(19) United States
(12) Patent Application Publication
(10) Pub. No.: US 2011/0220837 A1
(43) Pub. Date: Sep. 15, 2011

(54) SOLVENT-DISPERSIBLE PARTICLE

(75) Inventors: Shuzo Tokumitsu, Kanagawa (JP); Yuki Hirajima, Tokyo (JP)

(73) Assignee: Hoya Corporation, Tokyo (JP)

(21) Appl. No.: 12/676,673

(22) PCT Filed: Sep. 8, 2008
(86) PCT No.: PCT/JP2008/066505

§ 371 Date: Jun. 1, 2011

(30) Foreign Application Priority Data
Sep. 7, 2007 (JP) 2007-233117

(51) Int. Cl. H01F 1/42

(52) U.S. Cl. 252/62.51 R

(57) ABSTRACT

A solvent-dispersible particle including, a nanoparticle including two or more metallic components, and surface modifiers for covering the surface of the nanoparticle. The surface modifier includes, within its one molecule, two or more functional groups interacting with the two or more metallic components in the nanoparticle, respectively, and one or more functional groups having affinity for a solvent in which the nanoparticle is dispersed.

The present application claims priority from PCT Patent Application No. PCT/JP2008/066505 filed on Sep. 8, 2008, which claims priority from Japanese Patent Application No. 2007-233117 filed on Sep. 7, 2007, the disclosure of which is incorporated herein by reference in its entirety.

### BACKGROUND OF THE INVENTION

1. Field of the Invention

The present invention relates to a solvent-dispersible particle. More particularly, the present invention relates to a multi-metal component nanoparticle having an excellent dispersibility in liquid and, especially, to a magnetic nanocrystalline particle, which is expected to be applicable to high-density recording mediums.

2. Description of Related Art

Since a nanocrystalline particle, such as FePt and CoPt, possesses high crystalline magnetic anisotropy in an ordered phase, its application to a high-density recording medium is promising. As a method for fabricate a recording medium consisting of nanocrystalline particles, a method is known in which nanocrystalline particles and a substrate are combined, thereby forming a thin film. In order to use this method, however, it is required to increase frequency of collisions between the nanocrystalline particles and the substrate. Therefore, it is necessary to improve dispersibility of the nanocrystalline particles in solvent. With respect to FePt and CoPt, in general, it is known that a particle is well dispersed in a nonpolar solvent such as toluene or hexane, when the surface of the particle is modified with oleic acid and oleylamine. It has been reported that FePt nanoparticles, whose surfaces were modified with oleic acid and oleylamine, were fixed on a substrate modified by [3-(2-Aminoethlamino)propyl]trimethoxysilane (cf. Yu, A. C. C. et. al, Appl. Phys. Lett., 82 (2003)4352, for example).

It has been reported that by displacing the surface modification of FePt alloy nanocrystalline particles, whose surfaces were modified with oleic acid and oleylamine, using mercaptocarboxylic acid, an aqueous solution in which nanocrystalline particles were disparsed was obtained (cf. Sun, X. et. al, J. Appl. Phys. 97 (2005)10Q901-1, and, Bagaria H. G. et. al, Langumir 22 (2006)7782, for example).

As described above, it is known that, for FePt and CoPt, the nanocrystalline particles disperse well in a solvent, if two types of surface modifiers, that are oleic acid and oleylamine, are used. In this case, it is considered that the carboxyl group of oleic acid adsorbed Fe(Co) on the surface of the nanocrystallin particle, and the amino group of oleylamine adsorbed Pt on the surface of the nanocrystalline particle. In the above publication of Yu, A. C. C. et al., FePt whose surface is modified with oleic acid and oleylamine is fixed on the substrate covered with a monolayer. However, it is possible that because of their long chains of molecules, oleic acid and oleylamine act as steric barriers for combining FePt with the substrate. For other surface modifiers, the above publications of Sun, X. et al. and Bagaria, H. G. have reported fabrication of water-dispersible alloy nanocrystalline particles. However, it has been reported that, in this method, only oleylamine is displaced by mercaptocarboxylic acid, and oleic acid keeps residing on the surface of the nanoparticle. It can be considered that oleic acid residing on the nanoparticle is a steric barrier for bonding between the nanoparticle and the substrate.

### SUMMARY OF THE INVENTION

The objective of the present invention is to provide, under such circumstances, a multi-metal component nanoparticle which is superior in dispersibility in a solvent, and which has a good connectivity for a substrate, and especially, to provide a magnetic nanocrystalline particle which is expected to be applied for high-density recording mediums.

As a result of researches to develop a multi-component alloy nanoparticle with the above described desirable properties, inventors of the present invention have found that it is possible to accomplish the objective by covering the surface of a multi-component alloy nanoparticle with a specific surface modifier, and have accomplished this invention based on this knowledge. In the present invention, a multi-component alloy is said to be an alloy including two or more metal components (metal elements). Its state, for example, a solid solution, an intermetallic compound, a single crystal, a poly crystal, or an amorphous substance, is not considered. In any of these states, the effect of the present invention can be obtained, provided that the nanoparticle includes two or more metal components. Namely, the present invention provides:

(1) a solvent-dispersible particle including: a nanoparticle (a multi-component alloy nanoparticle) including two or more metal components; and surface modifiers for covering the surface of the nanoparticle, wherein the surface modifier includes, within its one molecule, two or more functional groups interacting with (e.g., combining or adsorbing) the two or more metal components in the multi-component alloy nanoparticle, respectively, and one or more functional groups having affinity for a solvent in which the multi-component alloy nanoparticle is dispersed,

(2) the solvent-dispersible particles described in (1) above, wherein the multi-component alloy nanoparticle includes: a group of elements A including one or more elements selected from the transitional metal elements belonging to the 4th period of the periodic table (long format), except for Cu; and a group of elements B including one or more elements selected from the elements belonging to the platinum group elements and the elements belonging to the 11th group of the periodic table,

(3) the solvent-dispersible particle described in (2) above, wherein the group of elements A includes at least one element selected from Fe, Co, and Ni,

(4) the solvent-dispersible particle described in any of (1)-(3) above, wherein the functional groups interacting with the two or more metallic components in the multi-component alloy nanoparticle, respectively, include: a functional group which can become a soft base; and a functional group which can become a hard base, (5) the solvent-dispersible particle described in one of (2)-(4) above, wherein the functional groups interacting with the two or more metallic components included in the multi-component alloy nanoparticle, respectively, include: a functional group which can become a hard base which interacts with the group of elements A and a functional group which can become a soft base which interacts with the group of elements B,

(6) the solvent-dispersible particle described in one of (1)-(5) above, wherein the solvent in which the multi-component alloy nanoparticle is dispersed is a polar solvent, and wherein the functional groups having affinity for the solvent in which the multi-component alloy nanoparticle is dispersed are functional groups which show polar characteristics,

(7) the solvent-dispersible particle described in one of (1)-(5) above, wherein the solvent in which the multi-component alloy nanoparticle is dispersed is a non-polar solvent, and wherein the functional groups having affinity for the solvent in which the multi-component alloy nanoparticle is dispersed are low polar functional groups or non-polar functional groups, and,

(8) the solvent-dispersible particle described in one of (1)-(7) above, wherein the solvent-dispersible particle is used as a raw material for forming a deposited film of nanoparticles on a substrate, and wherein the surface modifier has, in its one molecule, one or more functional groups for forming a chemical bond with a functional group on the surface of the substrate.

According to the present invention, it is possible to provide a solvent-dispersible multi-component alloy nanoparticle whose surface is covered with a specific modifier, and which is superior in solvent dispersibility. Furthermore, it is possible to provide a solvent-dispersible magnetic alloy nanocrystalline particle which is particularly expected to be applicable to high-density recording mediums.

### BRIEF DESCRIPTION OF THE DRAWINGS

FIG. 1 shows an XRD pattern of CoPt nanocrystalline particles and an XRD pattern of CoPt nanocrystalline particles whose surfaces are modified with mercaptosuccinic acid.

FIG. 2 is a conceptual diagram illustrating the difference between a bonding state of a nanoparticle and a surface modifier in the present invention and a bonding state of a nanoparticle and surface modifiers in a conventional technique.

FIG. 3 is a conceptual diagram illustrating the difference between a bonding state of a nanoparticle and a surface modifier in the present invention and a bonding state of a nanoparticle and surface modifiers in a conventional technique.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

A solvent-dispersible particle of the present invention is characterized in that the particle includes a multi-component alloy nanoparticle (a nanoparticle including two or more metal components) and a surface modifier for covering the surface of the particle, and that the surface modifier includes, within its one molecule, two or more functional groups interacting with (e.g., a bonding such as a coordinate bonding, an adsorption) the two or more metallic components included in the multi-component alloy nanoparticle, respectively, and one or more functional groups having affinity for a solvent in which the multi-component alloy nanoparticle is dispersed.

[Multi-Component Alloy Nanoparticle]

In a solvent-dispersible particle of the present invention, a multi-component alloy nanoparticle (a nanoparticle including two or more metal components) is an alloy particle including a group of elements A including one or more elements selected from the transitional metal elements belonging to the 4th period of the periodic table (long format), except for Cu, and a group of elements B including one or more elements selected from the elements belonging to the platinum group elements and the elements belonging to the 11th group of the periodic table can be considered.

In the group of elements A included in the multi-component alloy nanoparticle, the transitional metal elements belonging to the 4th period of the periodic table, except for Cu, include Sc, Ti, V, Cr, Mn, Fe, Co, and Ni. One of these elements can be included, or two or more of these elements may be included. However, it is preferable that at least one element selected from Fe, Co, and Ni is included, and it is more preferable that Fe and/or Co is included.

On the other hand, in the group of elements B included in the multi-component alloy nanoparticle, the platinum group elements include Ru, Rh, Pd, Os, Ir, and Pt, and the elements belonging to the 11th group of the periodic table include Cu, Ag, and Au. One of these elements can be included, or two or more of these elements may be included. However, it is preferable that at least one element selected from Ru, Rh, Pd, Os, Ir, and Pt is included, and it is more preferable that Pd and/or Pt is included.

For the multi-component alloy nanoparticle, an alloy particle includes Fe and/or Co, and, Pd and/or Pt is preferable as an magnetic alloy particle which is useful for high-density magnetic recording mediums and magnetoresistive elements. For the case of the magnetic alloy particle, it is preferable that the magnetic alloy particle is multi-component alloy nanocrystalline particle. Especially, when the multi-component alloy nanocrystalline particles have an ordered structure called the L1₀ structure in which Fe or Co atom layers and Pd or Pt atom layers are alternately laminated, they show high magnetic anisotropy in the direction of the axis of easy magnetization. The particles possess strong coercivity even if the diameter of the particles is less than or equal to 10 nm. Therefore, the multi-component alloy nanocrystalline particle is more suitable for a magnetic alloy particle.

(Fabrication of Multi-Component Alloy Nanoparticle)

There is no particular constraint for a method of fabricating a multi-component alloy nanoparticle. A conventionally well-known method, such as the polyol reduction method, for example, can be adopted. Specifically, a salt or a complex of the at least one metallic element selected from the group of elements A and a salt or a complex of the at least one metallic element selected from the group of elements B are dissolved in polyol, such as tetraethyleneglycol, and heated for about 0.5-5 hours at a temperature between 150° C. and 320° C., preferably between 200° C. and 300° C. In this case, it is preferable that the heating process is performed under an inert gas atmosphere, such as argon gas. Above all, when the group of elements A consists of Fe and/or Co and the group of elements B consists of Pd and/or Pt, magnetic alloy nanocrystalline particles with the L1₀ structure are obtained by mixing the obtained particles with salt matrices such as NaCl and heated for about 0.5-5 hours at a temperature between 500-700° C. under reductive atmosphere, such as H₂/Ar.

Examples of the aforementioned salts or complexes of the metallic components include, chloride, sulfate, nitrate, carboxylate, acetylacetonato complex, ethylenediamine complex, amine complex, cyclopentadienyl complex, tripenylphosphine complex, and π-allyl complex.

Further, it is preferable that the percentages of use of the salts or complexes of the metallic components of the group of elements A and the salts or complexes of the metallic components of the group of elements B are stoichiometric quantities based on the compositions of the alloy particle to be formed.

After the reactions are completed, the multi-component alloy nanoparticles are obtained by applying a conventionally well-known solid and liquid separation process, such as centrifugal separation, after washing the reaction solution thoroughly with ethanol, for example.

The average particle diameter of the multi-component alloy nanoparticles thus obtained is normally 1-10 nm, and preferably 3-8 nm. Here, the average particle diameter is the value measured with the small-angle X-ray scattering technique.

(Surface Modifiers)

For a solvent-dispersible particle of the present invention, a surface modifier used for covering the surfaces of the above obtained multi-component alloy nanoparticle (a nanoparticle including two or more metal components) is required to have two or more functional groups which interact with (e.g., a bonding such as a coordinate bonding, an adsorption) the two or more metal components contained in the multi-component alloy nanoparticle, respectively, and to have one or more functional groups which have affinity for a solvent in which the multi-component alloy nanoparticle is dispersed.

Further, for the case in which the solvent-dispersible particles of the present invention are used as a raw material for forming a deposited film of alloy nanoparticles on a substrate, it is preferable that the surface modifier includes, within its one molecule, one or more functional groups for forming a chemical bonding with a functional group of the substrate.

Here, as the two or more functional groups which interact with the two or more metal components in the multi-component alloy nanoparticle, respectively, the functional group which interacts with the group of elements A is denoted by X-a, and the functional group which interacts with the group of elements B is denoted by X-b, the one or more functional groups which have affinity for a solvent are denoted by Y, and the one or more functional groups for forming a chemical bonding with a functional group on the substrate are denoted by Z. Then, a surface modifier which has the functional groups X-a, X-b, Y, and Z in its one molecule can be used as the surface modifier. Further, a functional group Y having affinity for a solvent can be a functional group Z, at the same time, for forming a chemical bonding with a functional group on the substrate. Furthermore, a functional group Y having affinity for a solvent can be a surface modifier having 4 functional groups, X-a, X-b, Y, and Z, respectively, in its one molecule.

The functional groups X-a and X-b in a surface modifier are supposed to be combined with metal components of the group of elements A and metal components of the group of elements B in a multi-component alloy nanocrystalline particle, respectively, mainly through coordinate bonds.

The coordinate bonds are formed by electron donors as Lewis bases and electron acceptors as Lewis acids. For the multi-component alloy nanocrystalline particle of the present invention, in the relationship between the group of elements A and the functional group X-a of the surface modifier and the relationship between the group of elements B and the functional group X-b of the surface modifier, the group of elements A and B act as Lewis acids, and the functional groups X-a and X-b act as Lewis bases.

(HSAB Rule)

On the other hand, for reactions between Lewis acids and Lewis bases, the HSAB rule is known (hard and soft acids and bases rule). Here, “hard acids” include cations that are difficult to be polarized because of their high charge states and smallness in size, and “soft acids” include cations that are relatively easy to be polarized because of their low charge states and largeness in size. Further, “hard bases” include small bases that are difficult to be polarized because of their large electronegativities, and “soft bases” include large bases that are easy to be polarized because of their small electronegativities. There are acids and bases that are intermediate between these states. The HSAB rule is an empirical rule that “hard acids” tend to react with “hard bases” and “soft acids” tend to react with “soft bases.”

In the present invention, the group of elements A and the group of elements B of the multi-component alloy nanoparticle act as Lewis acids, respectively, and the functional groups X-a and X-b of the surface modifier act as Lewis bases, respectively. Here, in the present invention, the multi-component alloy nanoparticle has a structure such that “hard acid” and “soft acid” coexist as metallic components while the surface modifier has a structure such that “hard base” and “soft base” coexist in one molecule of the surface modifier.

Since, in these structures, “hard acids” tend to interact with “hard bases” and “soft acids” tend to interact with “soft bases,” the interactions between the surface modifiers and the surfaces of the multi-component alloy nanoparticles are strengthened. Thus, with these structures the surface modifiers can cover the surfaces of the nanoparticles. Further, in the present invention, the surface modifier also has, in its one molecule, a functional group Y which has affinity for a solvent. Therefore, the solvent-dispersible particles has been realized.

In the present invention, it suffices that the multi-component alloy nanoparticle has a structure such that “hard acid” and “soft acid” coexist as metallic components. However, “hard acids” and “soft acids” are not always clearly categorized, and they are relatively categorized, in certain extent. As described above, there are acids and bases with intermediate properties. Even though acids and bases have intermediate properties, if the acids coexist with “hard acids,” then the acids act as “soft acids,” and if the acids coexist with “soft acids,” then the acids act as “hard acids.” Therefore, in the present invention, the effect of the invention is obtained depending on the difference between the poralizabilities of the respective metallic components (the effect of the present invention is increased, provided that the difference between the poralizabilities is large and corresponding bases are selected). In the present invention, the platinum group elements and elements belonging to the 11th group of the periodic table, which tend to be in low charge states and tend to be large in size, are preferable as “soft acids.” As “hard acids” coexisting with “soft acids,” the transitional metal elements belonging to the 4th period of the periodic table, except for Cu, are preferable, and Fe, Co, and Ni are especially preferred, from the viewpoint of easiness of forming layers of ordered alloys.

(Functional Groups in a Surface Modifier)

In the present invention, as described above, as a surface modifier, a surface modifier whose functional group include a functional group which can become a hard base and a functional group which can become a soft base, while interacting with (e.g., a bonding such as a coordinate bonding, an adsorption) the two or more metallic components in the multi-component alloy nanoparticle, respectively, is preferable. Specifically, a surface modifier whose functional groups include a functional group X-a which interacts with the group of elements A and which can become a hard base and a functional group X-b which interacts with the group of elements B and which can become a soft base, while interacting with the two or more metallic components in the multi-component alloy nanoparticle, respectively, can be considered.

As a functional group X-a the following can be considered: a first amino group, a second amino group, a third amino group, a carboxyl group and its deprotonated form, a hydroxy group and its deprotonated form, an ether group, a phosphine oxide group, further, a phosphonate group, a phosphinate group, a phosphate group, a sulfonate group, a β-diketone group, and their deprotonated forms, for example.

On the other hand, as a functional group X-b, the following can be considered: an aromatic amino group, a pyridyl group, an amide group, a mercapto group and its deprotonated form, a sulfide group, a phosphine group, a phosphite ester group, a thiophene group, an ethene group, an alkyl group, a cyano group, a thiocyano group, sulfoxide group, and a sulfonic group, for example.

A surface modifier used in the present invention includes one or more functional group Y which has affinity for the solvent in which the multi-component alloy nanoparticles are dispersed. Here, when the solvent is a polar solvent, it is preferable that the functional group Y is a functional group which shows polarity.

Further, a polar solvent is a liquid including polar molecules having high relative permittivity (molecules having permanent dipoles). Polar solvents can be illustrated by examples, such as water, methanol, acetic acid, and acetone.

Further, a hydrophilic group which is usually known as a surfactant can be considered as a functional group which shows polar character (hydrophilic property). Examples of such hydrophilic groups include —COO⁻, —SO₃⁻, —PO₃²⁻, —NH₃⁺, R₃N⁺, a hydroxyl group, —O—, an ethylene glycol group.

On the other hand, when the solvent is a nonpolar solvent, a low polarity functional group or a nonpolar functional group is preferable as a functional group Y. Further, a nonpolar solvent is a liquid including nonpolar molecules having low relative permittivity (molecules having no permanent dipoles). Nonpolar solvent can be illustrated by examples, such as benzene, carbon tetrachloride, and hexane.

Further, a functional group which shows hydrophobic property (lipophilic property) and a hydrophobic group which is usually known as a surfactant can be considered as a low polarity functional group or a nonpolar functional group. Examples of such a functional group which shows hydrophobic property and a hydrophobic group include a straight alkyl group, a branched alkyl group.

In the present invention, when the solvent in which the multi-component alloy nanocrystalline particles are dispersed is a polar solvent and the functional group Y of the surface modifier is a functional group which shows polar character, water can be used as a dispersant solvent. Thus, the present invention is advantageous from the viewpoints of easiness of use, simplification of process, and environmental health.

When the solvent dispersible particle of the present invention is used as a raw material for forming a deposited film of alloy nanoparticles (nanoparticles including two or more metallic components) on a substrate, it is preferable that the surface modifier further includes one or more functional group Z for forming a chemical bonding with the functional groups on the surface of the substrate, in one molecule of the surface modifier. Further, the functional group Y which has an affinity for the solvent can be the functional group Z at the same time.

The combination of the functional group on the surface of the substrate and the functional group Z in the surface modifier (irrespective of which one is on the substrate's side and which one is on the surface modifier's side) for forming a chemical bonding between the functional group on the surface of the substrate and the functional group Z in the surface modifier includes, for example, a carboxyl group and an amino group, an acid anhydride group and an amino group, a carboxyl group and a hydroxyl group, an acid anhydride group and a hydroxyl group, a hydroxyl group and a —ClCO group, a hydroxyl group and a halogen group, an alkenyl group (C═C bonding) and a hydrosilyl group, an alkenyl group and a hydroboron group, an alkenyl group and a 1,3-diene group, an amino group and a —ClCO group, a phenyl group and a —ClCO group, a phenyl group and an acid anhydride group, a phenyl group and an alkyl group, a phenyl group and a benzyl group, a benzyl group and an'amino group, an aldehyde group and an amino group, a hydroxyl group and —OSi group, an isocyanate group and an amino group, an isocyanate group and a hydroxyl group, and an epoxy group and a hydroxyl group.

For example, when forming a deposited film of alloy nanoparticles on a substrate, usually, the surface of the substrate is processed with a silane coupling agent, and a film of the silane coupling agent is formed. As a silane coupling agent, in general, a silane coupling agent having an amino group at its end, such as 3-aminopropyltriethoxysilane or [3-(2-amino-ethlamino)-propyl]-trimethoxysilane, is used. In this case, a carboxyl group is advantageous as the functional group Z, from the viewpoint of reactivity with an amino group in a silane coupling agent.

When a polar solvent is used as a dispersant solvent and a functional group having polar character, such as a carboxyl group, for example, is used as the functional group Y having an affinity for the polar solvent, then the functional group Y can be the above functional group Z, at the same time.

Further, when a surface modifier has short molecular chains, or when a surface modifier has no bulky group, the possibility that a bonding with a substrate is failed because of a steric barrier is reduced. Therefore, it is preferable that a surface modifier has short molecular chains or a surface modifier is a low molecule.

(Covering with Surface Modifiers)

As a surface modifier for covering the surface of a multi-component alloy nanoparticle (a nanoparticle having two or more metal components), as described above, a surface modifier which has the functional groups X-z, X-b, Y, and Z is preferable, and especially a surface modifier which allows water to be used as a dispersant solvent is preferred. For such a surface modifier, there is no particular constraint, and various chemical compounds, for example, mercaptosuccinic acid, 2,3-dimercaptosuccinic acid, 2,4-diaminobenzoic acid, 2,4-pyridinedicarboxylic acid (these are for a polar solvent), 5-butylpicolinic acid, N-acetyl norleucine, 2-hydroxy-7-propylquinoline, and N-lauroyl sarcosine (these are for a non-polar solvent), can be considered. Among these chemical compounds, mercaptosuccinic acid allows water to be used as a dispersant solvent, and whose dispersibility in water is excellent. Mercaptosuccinic acid can provide solvent dispersible particles having excellent associativity with a substrate. Thus, mercaptosuccinic acid represented by the formula (1) below is preferable.

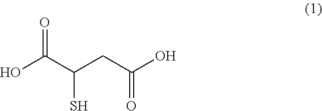

Next, with an example in which water, being a polar solvent, is used as a solvent, a method of covering a surface of a multi-component nanoparticle with a surface modifier is explained.

First, an aqueous solution including about 5-50 percent concentration by mass of surface modifiers, such as mercaptosuccinic acid, is prepared. Next, mix separately fabricated multi-component alloy nanocrystalline particles in the above aqueous solution including the surface modifiers so that the ratio between the multi-component alloy nanoparticles and the surface modifiers becomes 1:10-1:100 by mass. After that, the aqueous solution is kept agitated for about 2-24 hours at ambient temperature, and preferably, the aqueous solution is kept agitated for about 12-20 hours. After finishing agitation, the precipitates are removed by a centrifugal separation process. Then, a solution in which multi-component alloy nanoparticles are dispersed is obtained as a supernatant solution. Depending on a need, a process of dialysis can be applied to the solution in which multi-component alloy nanoparticles are dispersed, and the impurities can be removed. In this manner, solvent dispersible particles of the present invention can be fabricated.

The inventors of the present invention have considered that “nanoparticles having high dispersibility in a solvent” implies that “the nanoparticles are stably dispersed in a solvent.” The inventors of the present invention have considered that in order that “the nanoparticles are stably dispersed in a solvent,” it is necessary that “the surfaces of the nanoparticles have structures which ensure dispersibility (the surface modifiers combine with (by “bondings” including adsorption between the surface modifiers (and their functional groups) and the surfaces of nanoparticles, hereinafter) the surfaces of the nanoparticles such that the surface modifiers are in a state which ensures dispersibility),” and that “the surface modifiers combining with the surfaces of the nanoparticles have structures which are not easily-removable.” As “a structure for ensuring dispersibility,” it is required that the surface modifier on the surface of nanoparticle has a functional group having an affinity for the solvent on the solvent's side (namely, on the opposite side of the nanoparticle).

Namely, it follows that in order to realize “nanoparticles having high dispersibility in a solvent,” it is necessary that many surface modifiers combine with the surfaces of the nanoparticles such that these surface modifiers are not easily-removable, while arranging the functional groups having affinity for the solvent outside.

For example, MPA (mercaptopropionic acid) used in the reference example described below has an —SH group and a —COOH group at its both ends. When MPA is arranged on the surface of CoPt nanocrystalline as a surface modifier and dispersed in a solvent (e.g., water), there are three possibilities for ways to combine MPA: 1) the —COOH group combines with the Co site on the surface of the nanoparticle, 2) the —SH group combines with the Pt site, and 3) both of the groups combine.

Here, when the —SH group combines with the Pt site, the —COOH group is remaining at the other end of the surface modifier, so the —COOH group is on the water side. Since water is the solvent, the —COOH group is a functional group having a high affinity for the solvent. Thus, the —COOH group becomes the functional group contributing to the dispersibility in the solvent. On the other hand, when the —COOH group combines with the Co site, only the —SH group is remaining at the other end of the surface modifier. It can be a cause of reducing the dispersibility of the nanoparticles in the solvent. Further, when the functional groups of the surface modifier combine with both the Pt site and the Co site, there is no functional group remaining on the solvent side. Thus, when MPA is the surface modifier, there is a possibility that two types of functional groups, the —COOH group and the —SH group, can be on the solvent side. Since the —COOH group has a high affinity for the solvent (contributing to the dispersibility in the solvent), the greater the percentage of the —COOH group is, the higher the dispersibility of the nanoparticles in the solvent. When MPA is used as the surface modifier and the nanoparticle is dispersed in water, being a solvent, it is necessary that almost all the surface modifiers combining with the surfaces of the nanoparticles have a structure such that the —COOH group is on the solvent side. However, in such a condition, it is virtually difficult to control the surface modifiers such that they combine with the surfaces of the nanoparticles. This is a problem caused by the fact that two or more metals are exposed on the surface of the nanoparticle.

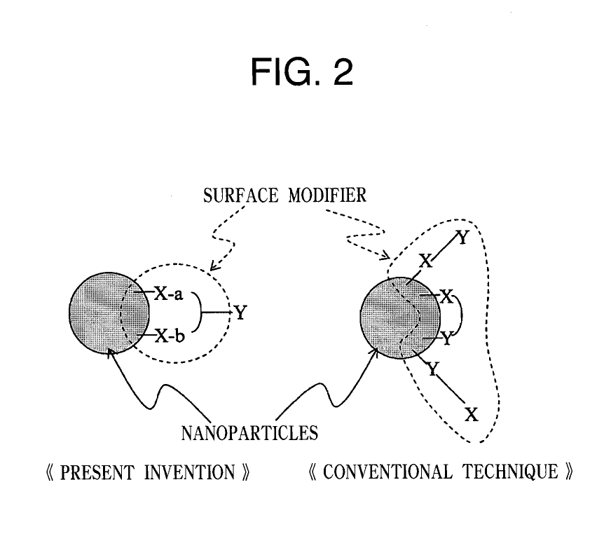

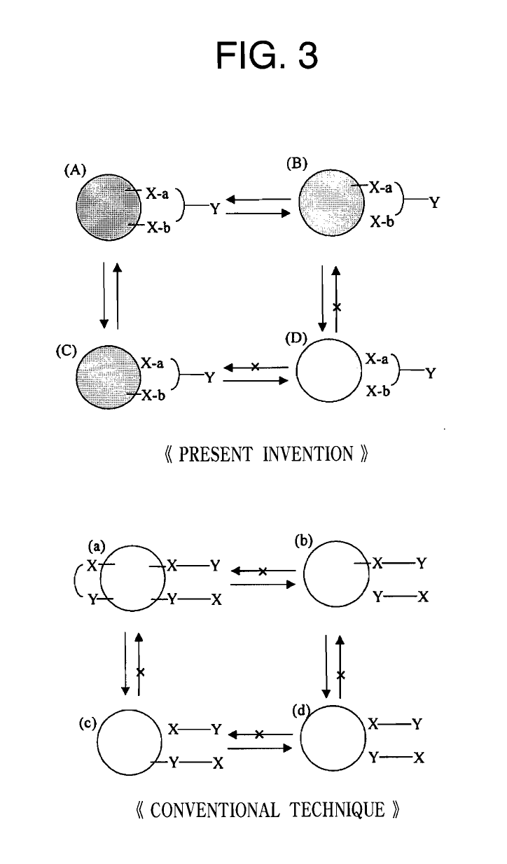

The differences between the present invention and a conventional technique are explained using FIG. 2 and FIG. 3. FIG. 2 is a conceptual diagram illustrating bonding states of the surface modifiers to the surfaces of the multi-component alloy nanoparticles. X, X-a, X-b, Y represent the functional groups in the surface modifiers. X, X-a, X-b are functional groups which interact with (e.g., a bonding such as a coordinate bonding, an adsorption) the metal components in the nanoparticles. Y is a functional group which contributes to the dispersibility in the solvent (a functional group having an affinity for the solvent). In surface modifiers such as the above described MPA, Y is a functional group which can interact with the metal components in the nanoparticles. There are three ways of combining, as in the conventional technique of FIG. 2. To satisfy the above described condition that “the surfaces of the nanoparticles have structures which ensure dispersibility,” it is required that the surface modifiers combine with the surfaces of the nanoparticles with a state in which Y is directed to the solvent side. According to the present invention, it is possible to realize “a structure with which the surfaces of the nanoparticles ensure dispersibility.”

FIG. 3 is a conceptual diagram illustrating the desorption equilibrium that can be considered based on the combined state of FIG. 2. Here, the case in which the surface modifier combines at two portions, X and Y, in one molecule of the surface modifier as in the conventional technique of FIG. 2 is omitted in FIG. 3. Needless to mention, but the solvent dispersibitily is not obtained in a state in which the functional group Y, contributing to the solvent dispersibility, is not combined with the surface of the nanoparticle. Thus, to be in one of the states (A), (B), (C), (a), or (b) is the minimum requirement. The surface modifier combining with the surface of the nanoparticle is in desorption equilibrium. However, once the surface modifier is “completely” released (detached) from the combined state, then the surface modifier is dispersed in the solvent. Thus, the possibility of recombination of the surface modifier is extremely low Namely, in the conventional technique, since there is only one connecting site connected with the surface of the nanoparticle, the surface modifier which is completely detached does not recombine. Thus, the number of surface modifiers combined with the surfaces of the nanoparticles keeps decreasing. On the other hand, in the present invention, even though the combining state of X-a or X-b is released, the surface modifier is not dispersed in the solvent, provided that the other combining state is remaining. Thus, the possibility of recombination is high, and it is possible to lower the possibility that the state becomes (D). Namely, according to the present invention, it is possible to realize “a structure such that the surface modifier combining with the surface of the nanoparticle is not easily detached.”

In view of above, even though there are many surface modifiers combining with the surface of the nanoparticle, if the surface modifier does not have a structure such that the functional group contributing to an affinity for the solvent is on the solvent side (namely, on the opposite side to the portion connected with the surface of the nanoparticle), then the solvent dispersibility of the nanoparticle is not obtained, as a result. Further, even if the surface modifier realizes a structure such that a functional group contributing to the affinity for the solvent is on the solvent side, if the surface modifier is not stably connected with the surface of the nanoparticle, then the solvent dispersibility lowers (corresponding to the detaching process of (a)→(b) (c)→(d) of FIG. 3).

Namely, it has been found that for a surface modifier combining with a surface of a nanoparticle, “solvent dispersibility” cannot be obtained by only having one of “a structure with which the surface modifier can combine with the surface of the nanoparticle such that the surface modifier is not easily removed” or “a structure such that the surface modifier has a functional group having an affinity for a solvent,” and it has been found that, in order to obtain “solvent dispersibility,” a structure including both of them, namely, “a structure in which an affinity for a solvent is always ensured irrespective of the condition of the bonding between the surface modifier and the surface of the nanoparticle” is required. Further, in order for a nanoparticle to be “stably” “dispersed in a solvent,” the surface modifier combining with the surface of the nanoparticle is required to have a structure such that the surface modifier is not easily detached. As a result of having earnestly examined to satisfy these, the present invention has been achieved. Namely, according to the present invention, for two or more metallic components exist on a surface of a nanoparticle, there exist, in a surface modifier, more than one functional groups combining with the surface of the nanoparticle. Therefore, the affinity for the solvent is ensured irrespective of the way with which the surface modifier is combined (connected portions). Further, having a structure such that the surface modifier can combine with the two or more constituent elements, “a structure with which the surface modifier can combine with the surface of the nanoparticle such that the surface modifier is not easily removed” have been realizable. According to the present invention, even if the number of the connected portions is increased, an affinity for a solvent can be ensured as a matter of course.

The solvent dispersible particles of the present invention has the following effects.

(1) Improvement of Dispersibility in a Solvent

Even if the composition of the surface of the multi-component alloy nanocrystalline is disproportionate to one of A and B, the surface modifiers can be combined with (including adsorption) the surfaces of the particles. Thus, the density of functional residual groups having a high affinity for the solvent on the surfaces of the nanoparticles increases, thereby allowing to improve the dispersibility of the nanoparticles in the solvent. By improving the dispersibility, it is possible to increase the concentration of the nanoparticles in the solvent. Thus, it is possible to facilitate the handling of fixing the nanoparticles on the substrate.

(2) Improvement of a Bonding Force, an Adsorption Force, to the Surface of the Nanocrystalline Particle

When the surface modifier combines with (including adsorption) the surface of the nanoparticle at two sites, that is, the functional group X-a combines with A of the surface of the nanoparticle and the functional group X-b combines with B of the surface of the nanoparticle, it is possible to strengthen the bonding to the surface of the nanoparticle, in comparison with the case where the surface modifier combines with the surface of the nanoparticles at one site. With this, it is possible to improve the dispersibility in the solvent.

(3) A Single Surface Modifier

A single surface modifier can be combined with (including adsorption) both A and B on the surface of the nanoparticle. When Y is a functional group which combines with the substrate at the same time, if a molecule having a short chain length is selected, then Y does not become a steric barrier for fixing the nanoparticles on the substrate. However, there is no necessity that a single modifier is combined with both A and B on the surface of the nanoparticle, one of them can be in “a combinable state.”

(4) Improvement of Stability of Dispersibility

The surface modifier combining with the surface of the nanoparticle has a structure such that the surface modifier can combine with the surface of the nanoparticle at two or more sites on the surface of the nanoparticle. Therefore, once the surface modifier combines with the surface of the nanoparticle, then the surface modifier is not easily detached from the surface of the nanoparticle, thereby obtaining the stable dispersibility in the solvent.

### EMBODIMENTS

Next, the present invention is further explained with embodiments. However, the present invention is not limited to these examples.

### Embodiment 1

### Fabrication of an Aqueous Solution in which CoPt Nanocrystalline Particles are Dispersed

(1) Synthesis of CoPt Nanocrystalline Particles

31.3 mg of Co (acac)₂ (made by Aldrich Company) and 49 mg of Pt (acac)₂ (made by Aldrich Company) (0.12 mmol, respectively) are mixed in 6 ml or tetraethyleneglycol (made by Kanto Chemical Company). The reaction solution is deaerated, after that, the reaction solution is heated for one hour at 270° C. under an argon gas atmosphere. On this occasion, the color of the solution turned into black at around 190-200° C. Next, the reaction solution is rinsed with ethanol. Then, a centrifugal separation process is performed with a centrifugal separator [made by Kubota Company, model name: “KUBOTA3700,” condition: 6000 rpm, 10 min], and CoPt nanocrystalline particles are obtained. The average particle diameter of the obtained CoPt nanocrystalline particles is 4.2 nm, according to a small-angle X-ray scattering device [made by Rigaku Company, model name: “Smart Lab”].

(2) Introduction of Surface Modifiers to CoPt Nanocrystalline Particles

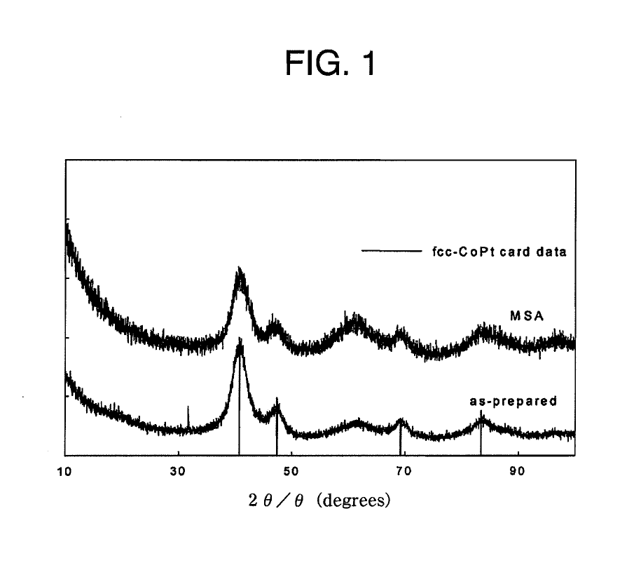

An aqueous solution of mercaptosuccinic acid [made by Tokyo Chemical Industry Company, hereinafter abbreviated as MSA] (2 ml of water to 200 mg of MSA) is added to the 0.04 mmol of the CoPt nano crystalline particles obtained in (1) above, and agitated for 16 hours at ambient temperature. Next, a centrifugal separation process is performed with the centrifugal separator (described above), and components which are non-dispersive in water are removed. Next, using a 30000 molecular weight cutoff dialysis filter [made by Sartorius Company, “VIVASPIN6”], the process of dialysis is repeated five times to the components which are dispersive in water (a supernatant solution), thereby removing redundant MSA, unnecessary Co ions, and unnecessary Pt ions. In this manner, a solution in which CoPt nanocrystalline particles having MSA as surface modifiers are dispersed is fabricated. With respect to the obtained solution in which CoPt nanocrystalline particles are dispersed, the water contained in the solution is vaporized, thereby forming a powder. With respect to the formed powder, the crystalline structure is evaluated by the X-ray diffraction [Rigaku Company, “SmartLab”] and the composition is evaluated by ICP elemental analysis. The result of X-ray diffraction is shown in FIG. 1. The lower XRD pattern in the figure is an XRD pattern of the CoPt nanocrystal synthesized by the polyol reduction method. The upper XRD pattern is an XRD pattern of the CoPt nanocrystal for which MSA have been used as surface modifiers. By comparing these patterns, it is seen that there is no big difference in the XRD pattern when MSA are coordinated, and the XRD patterns agree well with the fcc-CoPt card data. Further, the result of elemental analysis by ICP and the yield for CoPt nanocrystalline particles are shown in Table 1. Furthermore, the above yield is obtained as the ratio between “Co+Pt (mol)” contained in 2000 of the aqueous solution including CoPt nanocrystalline particles to which MSA are not added, after rinsing with ethanol, and “Co+Pt (mol)” contained in 2000 of the aqueous solution in which CoPt nanocrystalline particles to which MSA are added are dispersed.

(3) Fixing the CoPt Nanocrystalline Particles to the Substrate

A silicon substrate whose surface is covered with a monolayer of 3-aminopropyltriethoxysilane (hereinafter, abbreviated as APS), which is a silane coupling agent having an amino group at its end, is prepared and placed on a hot plate. A few drops of the aqueous solution, in which the CoPt nanocrystalline particles, obtained in (2) above, for which MSA are used as surface modifiers are dispersed, are dropped on the substrate, and the surface of the substrate is moistened with the solution. Next, the substrate is heated by increasing the temperature of the hot plate to 150° C., and the water on the substrate is vaporized. The dehydration condensation reaction occurs between the functional groups of both of the surface modifiers, that are the —COOH group of the surface modifier of the CoPt nanocrystalline particle and the —NH₂ group on the surface of the substrate, thereby fixing the CoPt nanocrystalline particle on the surface of the substrate. The reaction occurs only to the functional groups on the surface of the monomolecular film formed on the surface of the substrate. The reaction does not occur between the functional groups at the ends of molecules which are modifying the nanocrystalline particles. The unreacted nanocrystalline particles can be washed off from the substrate by washing the substrate with water after the reaction. Thus, only the CoPt particles fixed to the substrate by the amide bonding (—NHCO—) remain on the substrate.

In the present invention, mercaptosuccinic acid is used as a surface modifier. For the case in which mercaptosuccinic acid is used, when mercaptosuccinic acid is introduced to a particle, water can be used as a solvent. Therefore, for removal of redundant organic substances and ions, it suffices to apply only dialysis processes. The process can be shortened in several steps, in comparison with the case in which the surface modifiers are introduces without using water as a solvent. Therefore, it is preferable.

4) Verification of the Stability of Dispersibility in Solvent of the Nanoparticles Modified with MSA

A portion of the aqueous solution, obtained in (2), in which the CoPt nanoparticles modified with MSA are dispersed is collected. After that, water is added to the collected aqueous solution and 3 ml of the aqueous solution with the concentration of 0.01 mol/l is prepared. The pH of the aqueous solution was 9. The aqueous solution thus prepared had been left for one week at ambient temperature. After leaving one week, non-dispersible components are removed with centrifugal separation, and components which are dispersible in the solvent are collected. The concentration of the collected aqueous solution is calculated with ICP elemental analysis. The concentration was 80 percent of the concentration of the aqueous solution immediately after preparation.

### Reference Example 1

After synthesizing CoPt nanocrystalline particles as in the case of embodiment 1 (1), a proper amount (about 1 ml) of mercaptopropionic acid (made by Aldrich Company, hereinafter abbreviated as MPA) is added to 0.04 mmol of the CoPt nanocrystalline particles obtained by rinsing with ethanol followed by centrifugal separation, after that the CoPt nanocrystalline particles are agitated for one hour. After the agitation, the reaction solution is observed to be dispersed. After rinsing with ethanol twice, the particles are dispersed in 0.2 mol/L of NaOH aqueous solution, then the components that are not dispersible in water is removed by centrifugal separation. With respect to the components that are dispersible in water, a process of dialysis is repeated several times. In this manner, the aqueous solution in which the CoPt nanocrystalline particles, for which MPA are used as surface modifiers, are dispersed is prepared. The result of the elemental analysis by ICP and the yield for the CoPt nanocrystalline particles are shown in Table 1. Further, the yield are obtained as in the case of embodiment 1 (2).

TABLE 1

| | Co | Pt | Co + Pt | yield |
|---|---|---|---|---|
| | (μmol) | (μmol) | (μmol) | (%) |
| CoPt not modified | 7.0 | 7.5 | 14.5 | — |
| CoPt modified with MPA | 1.9 | 0.6 | 2.48 | 17 |
| CoPt modified with MSA | 1.2 | 2.9 | 4.10 | 28 |

As it can be seen in Table 1, the yield for the nanocrystalline particles coordinated by MPA is 17% and the yield for the nanocrystalline particles coordinated by MSA is 28%. By using MSA, the yield is 1.6 times improved. For MPA, there are some possibilities that the carboxyl group of MPA combines with the surface of Co, and the density of remaining carboxyl groups is small. Thus, there is not enough polarity, so that the nanocrystalline particles cannot be dispersed in water. For MSA, there are functional groups combine with Co and Pt, respectively, and, further, it has a carboxyl group as a remaining group. It is considered that the dispersibility of the nanocrystalline particles in water is improved because of (1) the improvement of bonding force to the surface of the nanocrystalline, and (2) the improvement of the density of carboxyl groups on the surface of the nanocrystalline particles.

A portion of the aqueous solution in which the CoPt nanoparticles modified with MPA are dispersed was collected as in the case of embodiment 1 (4), and the stability of the dispersibility of the aqueous solution was verified. The aqueous solution was prepared with the same method and concentration as in the case of embodiment 1 (4), and the aqueous solution had been left for one week at ambient temperature. After leaving one week, the concentration of the aqueous solution was calculated as in the case of embodiment 1 (4), but the concentration of the aqueous solution was below the limit of detection.

### Embodiment 2

### Fabrication of an Aqueous Solution in which FePt Nanocrystalline Particles are Dispersed

(1) Synthesis of FePt Nanocrystalline Particles

42.5 mg of Fe (acac)₃ (made by Aldrich Company) and 48 mg of Pt (acac)₂ (made by Aldrich Company) (0.12 mmol, respectively) are mixed in 6 ml of tetraethylenglycol (made by Kanto Chemical Company). The reaction solution is deaerated, after that, the reaction solution is heated for one hour at 270° C. under an argon gas atmosphere. On this occasion, the color of the solution turned into black at around 190-200° C. Next, the reaction solution is rinsed with ethanol. Then, a centrifugal separation process is performed with a centrifugal separator [made by Kubota Company, model name: “KUBOTA3700,” condition: 6000 rpm, 10 min], and FePt nanocrystalline particles are obtained. The average particle diameter of the obtained FePt nanocrystalline particles is 6.5 nm, according to a small-angle X-ray scattering device (described above). An aqueous solution in which FePt nanocrystalline particles, for which MSA is used as a surface modifier, are dispersed is prepared, using the obtained FePt nanoparticles and introducing surface modifiers to the FePt crystal with the same method as in the case of embodiment 1. As a result of an XRD measurement, it is confirmed that the FePt nanocrystalline particles thus obtained are fcc-FePt.

### INDUSTRIAL APPLICABILITY

A solvent-dispersible particle of the present invention is made by covering the surface of a multi-component alloy nanoparticle (a nanoparticle including two or more metallic components) with surface modifiers. The solvent-dispersible particle of the present invention has an excellent dispersibility in liquid, and it is expected to be applicable especially to high-density recording mediums.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims

1-8. (canceled)

9. A solvent-dispersible particle including:
a nanoparticle including two or more metallic components; and
surface modifiers for covering a surface of the nanoparticle,
wherein the surface modifier includes, within its one molecule, two or more functional groups interacting with the two or more metallic components in the nanoparticle, respectively, and one or more functional groups having affinity for a solvent in which the nanoparticle is dispersed.

10. The solvent-dispersible particle according to claim 9,
wherein the nanoparticle includes:
a group of elements A including one or more elements selected from transitional metal elements belonging to the 4th period of a periodic table (long format), except for Cu; and
a group of elements B including one or more elements selected from elements belonging to platinum group elements and elements belonging to the 11th period of the periodic table.

11. The solvent-dispersible particle according to claim 10,
wherein the group of elements A includes at least one element selected from Fe, Co, and Ni.

12. The solvent-dispersible particle according to claim 9,
wherein the functional groups interacting with the two or more metallic components in the nanoparticle, respectively, include:
a functional group which can become a soft base; and
a functional group which can become a hard base.

13. The solvent-dispersible particle according to claim 10,
wherein the functional groups interacting with the two or more metallic components in the nanoparticle, respectively, include:
a functional group which can become a hard base which interacts with the group of elements A; and
a functional group which can become a soft base which interacts with the group of elements B.

14. The solvent-dispersible particle according to claim 9,
wherein the solvent in which the nanoparticle is dispersed is a polar solvent, and
wherein the functional groups having affinity for the solvent in which the nanoparticle is dispersed are functional groups which show polar characteristics.

15. The solvent-dispersible particle according to claim 10,
wherein the solvent in which the nanoparticle is dispersed is a polar solvent, and
wherein the functional groups having affinity for the solvent in which the nanoparticle is dispersed are functional groups which show polar characteristics.

16. The solvent-dispersible particle according to claim 12,
wherein the solvent in which the nanoparticle is dispersed is a polar solvent, and
wherein the functional groups having affinity for the solvent in which the nanoparticle is dispersed are functional groups which show polar characteristics.

17. The solvent-dispersible particle according to claim 9,
wherein the solvent in which the nanoparticle is dispersed is a non-polar solvent, and
wherein the functional groups having affinity for the solvent in which the nanoparticle is dispersed are low polar functional groups or non-polar functional groups.

18. The solvent-dispersible particle according to claim 10,
wherein the solvent in which the nanoparticle is dispersed is a non-polar solvent, and
wherein the functional groups having affinity for the solvent in which the nanoparticle is dispersed are low polar functional groups or non-polar functional groups.

19. The solvent-dispersible particle according to claim 12,
wherein the solvent in which the nanoparticle is dispersed is a non-polar solvent, and
wherein the functional groups having affinity for the solvent in which the nanoparticle is dispersed are low polar functional groups or non-polar functional groups.

20. The solvent-dispersible particle according to claim 9,
wherein the solvent-dispersible particle is used as a raw material for forming a deposited film of nanoparticles on a substrate, and
wherein the surface modifier has, in its one molecule, one or more functional groups for forming a chemical bond with a functional group on the surface of the substrate.

21. The solvent-dispersible particle according to claim 10,
wherein the solvent-dispersible particle is used as a raw material for forming a deposited film of nanoparticles on a substrate, and
wherein the surface modifier has, in its one molecule, one or more functional groups for forming a chemical bond with a functional group on the surface of the substrate.

22. The solvent-dispersible particle according to claim 12,
wherein the solvent-dispersible particle is used as a raw material for forming a deposited film of nanoparticles on a substrate, and
wherein the surface modifier has, in its one molecule, one or more functional groups for forming a chemical bond with a functional group on the surface of the substrate.
